(19) United States
(12) Patent Application Publication
(10) Pub. No.: US 2014/0185302 A1
(43) Pub. Date: Jul. 3, 2014

(54) LIGHTING DEVICE

(71) Applicant: TOSHIBA LIGHTING AND TECHNOLOGY CORPORATION, Kanagawa (JP)

(72) Inventor: Osamu EBISAWA, Kanagawa (JP)

(73) Assignee: TOSHIBA LIGHTING AND TECHNOLOGY CORPORATION, Kanagawa (JP)

(21) Appl. No.: 13/830,196

(22) Filed: Mar. 14, 2013

(30) Foreign Application Priority Data
Dec. 28, 2012 (JP) 2012-288199

(51) Int. Cl. F21V 21/30; F21V 29/00; F21V 5/00

(52) U.S. Cl. CPC F21V 21/30; F21V 5/007; F21V 29/2262
USPC 362/311.01; 362/427

(57) ABSTRACT

According to embodiments, there is provided a lighting device that includes a lighting main body and a support portion. The lighting main body has an irradiation window that emits light. The support portion has a rotation stop member that is engaged with a protrusion provided in a first frame body to regulate the rotation of the first frame body. The rotation stop member is attached to a second frame body so as to be freely movable in a circumferential direction of a circle around a central axis of the second frame body, and is moved to a first regulation position that regulates the rotation of the first frame body in one direction around the central axis of the second frame body and a second regulation position that regulates the rotation thereof in the of direction.

### CROSS-REFERENCE TO RELATED APPLICATIONS

This application is based upon and claims the benefit of priority from the prior Japanese Patent Application No. 2012-288199, filed on Dec. 28, 2012; the entire contents of which are incorporated herein by reference.

### FIELD

Embodiments described herein relate generally to a lighting device.

### BACKGROUND

There has been a universal type lighting device capable of changing an irradiation direction of light. The universal type lighting device has a lighting main body provided with an irradiation window through which light is emitted, and rotates the lighting main body around an axis perpendicular to an attachment surface such as a ceiling. In such a lighting device, it is preferable to further increase a degree of freedom of the degree change.

### BRIEF DESCRIPTION OF THE DRAWINGS

FIG. 1 is a schematic perspective view that illustrates a lighting device related to a first embodiment;

FIGS. 2A and 2B are schematic side views that illustrate a part of the lighting device related to the first embodiment;

FIGS. 3A to 3C are schematic views that illustrate a first frame body related to the first embodiment;

FIG. 4 is a schematic view that illustrates a second frame body related to the first embodiment;

FIG. 5 is a schematic cross-sectional view that illustrates the first frame body and the second frame body related to the first embodiment;

FIG. 6 is a schematic perspective view that illustrates a part of the first frame body and a part of the second frame body related to the first embodiment;

FIG. 7 is a schematic perspective view that illustrates a part of the first frame body and a part of the second frame body related to the first embodiment;

FIGS. 8A and 8B are schematic top views that illustrate a part of the first frame body and a part of the second frame body related to the first embodiment;

FIG. 9 is a schematic exploded perspective view that illustrates a lighting main body related to the first embodiment;

FIG. 10 is a schematic partial cross-sectional view that illustrates the lighting main body related to the first embodiment;

FIG. 11 is a schematic cross-sectional view that illustrates the first frame body and a holding frame related to the first embodiment;

FIGS. 12A and 12B are schematic views that illustrate a radiator related to the first embodiment;

FIG. 13 is a schematic perspective view that illustrates a filter related to the first embodiment;

FIGS. 14A and 14B are schematic perspective views that illustrate the holding frame related to the first embodiment;

FIG. 15 is a schematic perspective view that illustrates a lighting device related to a second embodiment;

FIGS. 16A and 16B are schematic side views that illustrate a lighting main body and a first frame body related to the second embodiment;

FIG. 17 is a schematic cross-sectional view that illustrates the first frame body and a second frame body related to the second embodiment;

FIGS. 18A and 18B are schematic views that illustrate the second frame body related to the second embodiment; and

FIGS. 19A and 19B are schematic top views that illustrate a part of the first frame body and a part of the second frame body related to the second embodiment.

### DETAILED DESCRIPTION

According to the exemplary embodiments, there is provided a lighting device that includes a lighting main body and a support portion. The lighting main body has an irradiation window that emits light. The support portion has a first tubular frame body through which the lighting main body can be inserted, and a second tubular frame body through which the first frame body can be inserted. The support portion supports the lighting main body inserted through the first frame body in the state of inclining an optical axis of the light with respect to a central axis of the first frame body, and supports the first frame body inserted through the second frame body so as to be freely rotatable manner around a central axis of the second frame body. The support portion has a rotation stop member that is engaged with a protrusion provided in the first frame body to regulate the rotation of the first frame body. The rotation stop member is attached to the second frame body so as to be freely movable in a circumferential direction of a circle around the central axis of the second frame body, and is moved to a first regulation position that regulates the rotation of the first frame body in one direction around the central axis of the second frame body and a second regulation position that regulates the rotation thereof in the other direction.

Hereinafter, each embodiment will be described while referring to the drawings.

In addition, the drawings are schematic or conceptual, a relationship between a thickness and a width of each portion, a ratio of a size between the portions or the like may not be necessarily the same as the actual ones. Furthermore, even when indicating the same portion, in some cases, each dimension and ratio may be different depending on the drawings.

In addition, in the specification and each drawing, the same elements as described above in regard to the drawings are denoted by the same reference numerals, and the detailed descriptions thereof will be omitted.

### First Embodiment

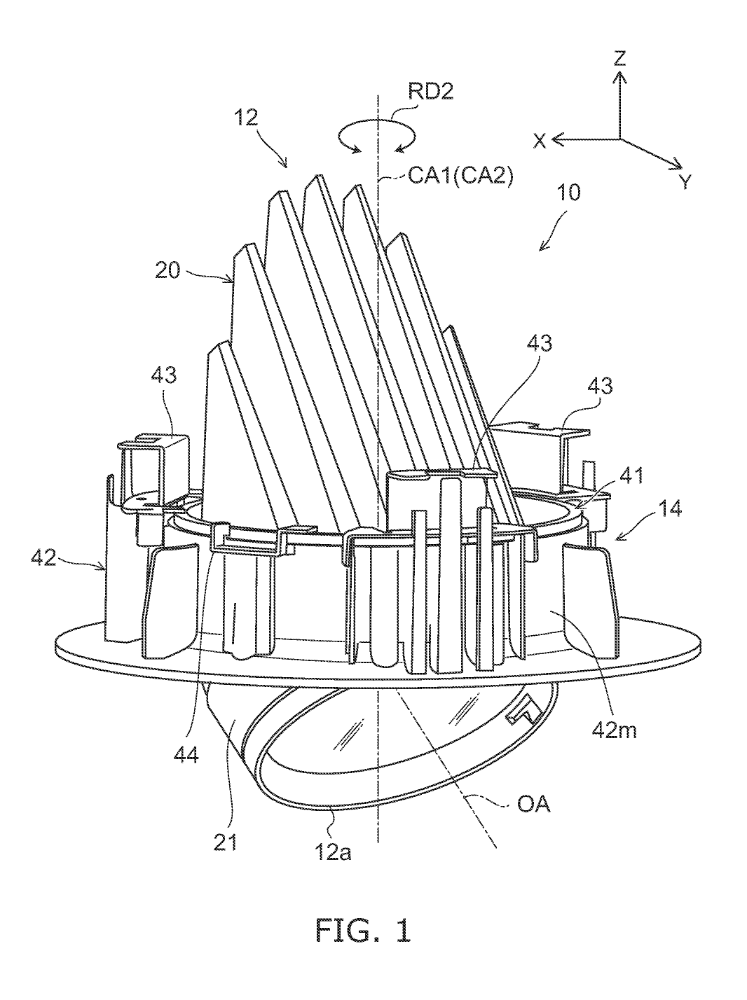

FIG. 1 is a schematic perspective view that illustrates a lighting device related to the first embodiment.

As illustrated in FIG. 1, a lighting device 10 includes a lighting main body 12 that irradiates the light toward an object, and a support portion 14 that supports the lighting main body 12.

The lighting main body 12 holds a light source therein. The lighting main body 12 has an irradiation window 12a for emitting the light (hereinafter, referred to as an illumination beam) generated from a light source. The illumination beam is emitted to the outside of the lighting main body 12 via the irradiation window 12a. Thereby, the object is irradiated with the illumination beam.

For example, the lighting main body 12 has a radiator 20 and a holding frame 21. For example, the radiator 20 performs the radiation of heat generated with the light emission or the light source. As the radiator 20, for example, a metallic material having high thermal conductivity such as aluminum is used. The holding frame 21 holds the radiator 20, a lens provided inside or the like. For example, the holding frame 21 has a tubular shape. In the example, the holding frame 21 has a cylindrical shape. In the example, one end of the holding frame 21 is an irradiation window 12a. The radiator 20 is attached to the other end of the holding frame 21. That is, the radiator 20 is provided on an opposite side of the irradiation window 12a.

The support portion 14 is used for supporting the lighting main body 12 and is used for attaching the lighting device 10 to an attachment object such as a ceiling plate. For example, the lighting device 10 is attached to the ceiling plate with the irradiation window 12a facing downward. For example, the lighting device 10 is embedded in an embedding hole provided in the ceiling plate. That is, the lighting device 10 is used as a so-called down-light. Hereinafter, an example of a case of using the lighting device 10 as the down-light will be described. However, for example, the attachment object of the lighting device 10 may be an inner wall plate or the like, without being limited to the ceiling plate. Furthermore, for example, the lighting device 10 may be attached to an exclusive attaching jig, and the lighting device 10 may be attached to the ceiling or the like via the attaching jig. That is, the attachment object of the lighting device 10 may be the attaching jig or the like.

The holding portion 14 has a first frame body 41 and a second frame body 42. The first frame body 41 and the second frame body 42 have a tubular shape. In the example, the first frame body 41 and the second frame body 42 have a cylindrical shape. The support portion 14 supports the lighting main body 12 so as to be freely rotatable in a state of being inserted through the first frame body 41. The first frame body 41 supports the inserted lighting main body 12 in a freely rotatable manner. In the example, the first frame body 41 supports the holding frame 21 in a freely rotatable manner. The first frame body 41 and the second frame body 42 may have for example, an arbitrary shape of a tubular shape such as a square tubular shape, without being limited to the cylindrical shape.

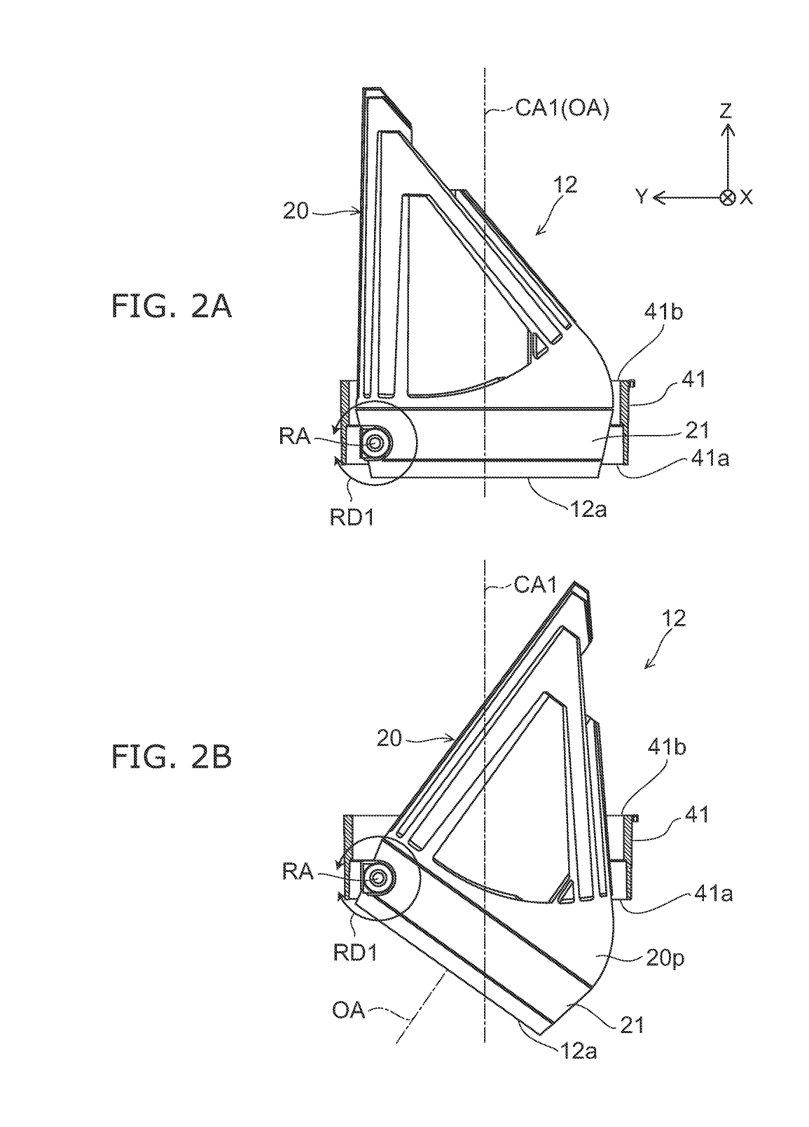

FIGS. 2A and 2B are schematic side views that illustrate a part of the lighting device related to the first embodiment.

FIGS. 2A and 2B illustrate the lighting main body 12 and the first frame body 41. Furthermore, in FIGS. 2A and 2B, in order to easily see the supported lighting main body 12, the first frame body 41 is illustrated in a cut state.

As illustrated in FIGS. 2A and 2B, the first frame body 41 rotates the lighting main body 12 around a rotation axis RA. The rotation axis RA is extended in a first direction perpendicular to a first central axis CA1 of the first frame body 41. Furthermore, the rotation axis RA is separated from the first central axis CA1 in a second direction perpendicular to the first central axis CA1 and the first direction. For example, the first central axis CA1 is an axis that is parallel to an extension direction of the first tubular frame body 41 and passes through a center of a cross-section perpendicular to the extension direction. Herein, the direction of the rotation of the lighting main body 12 around the rotation axis RA will be referred to as a “first rotation direction RD1”.

Herein, the direction parallel to the first central axis CA1 is referred to as a Z axis direction. One direction perpendicular to the Z axis direction is referred to as an X axis direction. A direction perpendicular to the Z axis direction and the X axis direction is referred to as a Y axis direction. In the example, the first direction is the X axis direction, and the second direction is the Y axis direction. That is, in the example, the rotation axis RA is extended in the X axis direction and is separated from the first central axis CA1 in the Y axis direction.

The first frame body 41 is able to move the lighting main body 12 to a first position illustrated in FIG. 2A and a second position illustrated in FIG. 2B, by rotating the lighting main body 12 in the first rotation direction RD1. At the first position, an optical axis OA of illumination beam is parallel to the first central axis CA1. Meanwhile, at the second position, the optical axis CA of illumination beam is inclined with respect to the first central axis CA1. Thereby, in the lighting device 10, an irradiated direction of the illumination beam can be changed. That is, the lighting device 10 is a so-called universal type lighting device. For example, the optical axis OA is an axis that passes through the center of light flux irradiated from the irradiation window 12a.

Furthermore, when locating the lighting main body 12 at the second position, the first frame body 41 projects a part 20p of the radiator 20 and the irradiation window 12a to the outside of the first game body 41 from one end 41a of the first frame body 41. The one end 41a is an end portion that faces in the same direction as the irradiation window 12a of the lighting main body 12 located at the first position in two end portions of the first frame body 41. In the example, at the second position, the entire irradiation window 12a is projected to the outside of the first frame body 41 from the one end 41a. For example, when the one end 41a is a lower end facing downward with respect to the ceiling, the first frame 41 locates the part 20p of the radiator 20 and the irradiation window 12a below the one end 41a of the first frame body 41.

Thereby, in the lighting device 10, even when inclining the optical axis OA with respect to the first central axis CA1, it is possible to suppress the blocking of the illumination beam due to the attachment object such as the device itself and the ceiling plate.

The second frame body 42 has a tubular main body portion 42m through which the first frame body 41 can be inserted. An inner diameter of the main body portion 42m of the second frame body 42 is greater than an outer diameter of the first frame body 41. The second frame body 42 supports the first frame body 41 inserted through the main body portion 42m around a second central axis CA2 of the main body portion 42m in a freely rotatable manner. Thereby, in the lighting device 10, by rotating the lighting main body 12 around the rotation axis RA and rotating the first frame body 41 and the lighting main body 12 around the second central axis CA2, the illumination beam can face in an arbitrary direction. For example, the second central axis CA2 is an axis that is parallel to an extension direction of the main body portion 42m and passes through a center of a cross-section perpendicular to the extension direction. Hereinafter, a direction of rotation or the first frame body 41 and the lighting main body 12 around the second central axis CA2 will be referred to as a “second rotation direction RD2”.

For example, the main body portion 42m coaxially supports the first frame body 41. That is, in the example, the second central axis CA2 of the main body portion 42m is substantially the same as the first central axis CA1 of the first frame body 41. The second central axis CA2 may not be necessarily the same as the first central axis CA1.

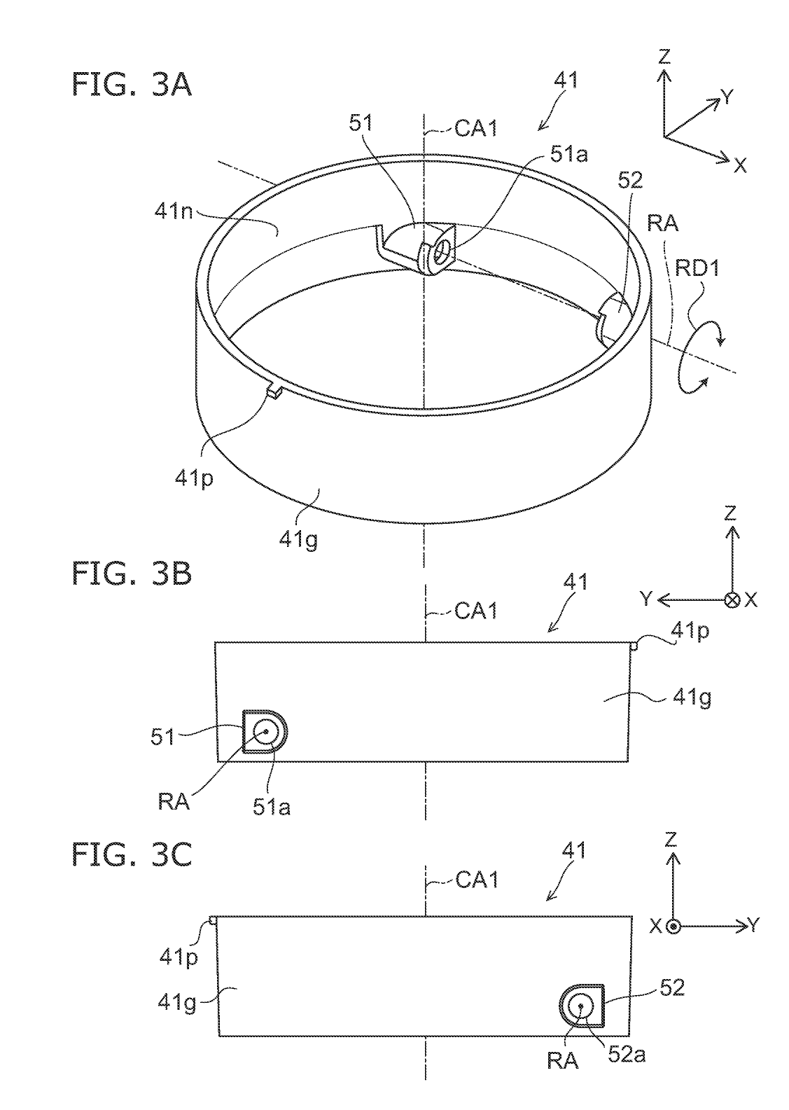

FIGS. 3A to 3C are schematic views that illustrate the first frame body related to the first embodiment.

FIG. 3A is a schematic perspective view, FIG. 3B is a schematic right side view, and FIG. 3C is a schematic left side view.

As illustrated in FIGS. 3A to 3C, on an inner surface 41n of the first frame body 41, a pair of bearing portions 51 and 52 projected toward the central direction is provided. The bearing portion 51 is also provided with a through hole 51a extended along the X axis direction. Similarly, the bearing portion 52 is provided with a through hole 52a extended along the X axis direction. The through hole 52a is provided at a position continued to the through hole 51a in the X axis direction. The diameter of the through hole 52a is substantially the same as the diameter of the through hole 51a. Thereby, the rotation axis RA is set at a position separated in the Y axis direction from the first central axis CA1 by the through holes 51a and 52a of the bearing portions 51 and 52.

In the example, the distance along the Y axis direction between the first central axis CA1 and the rotation axis RA is shorter than the radius of the inner diameter of the first frame body 41. Thereby, for example, at the second position, the entire irradiation window 12a can be suitably projected to the outside of the first frame body 41 from the one end 41a of the first frame body 41. Furthermore, for example, at the first position, the position of the optical axis OA can be substantially the same as the position of the first central axis CA1. That is, at the first position, the lighting main body 12 can be placed in the center of the first frame body 41. Thereby, for example, the exterior of the lighting device 10 can be improved.

Furthermore, the first frame body 41 is provided with a protrusion 41p. The protrusion 41p is projected outward from an outer surface 41g of the first frame body 41. The protrusion 41p is used for regulating the rotation of the first frame body 41 in the second rotation direction RD2.

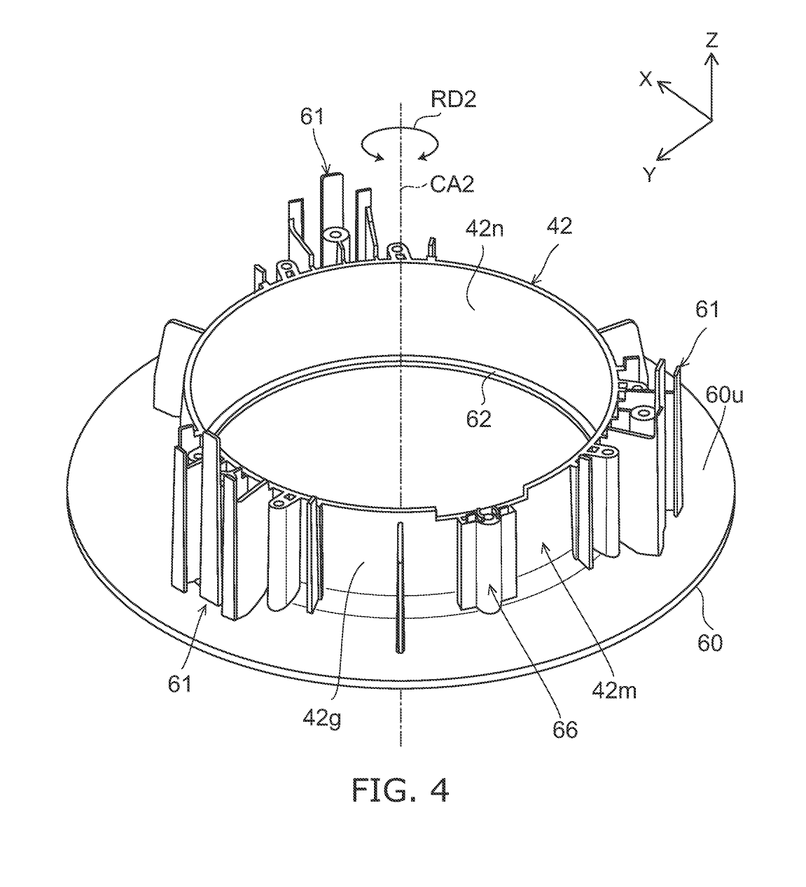

FIG. 4 is a schematic view that illustrates the second frame body related to the first embodiment.

The second frame body 42 is provided with a flange portion 60 and a plurality of spring attachment portions 61. The flange portion 60 is provided in one end of the main body portion 42m. The flange portion 60 is projected outward from an outer surface 42g of one end of the main body portion 42m. For example, the plurality of spring attachment portions 61 is placed around the second central axis CA2 at equal intervals. In the example, three spring attachment portions 61 are provided in the second frame body 42. The number of the spring attachment portions 61 may be arbitrary numbers of two or more, without being limited to three. An attaching spring (not illustrated) is attached to each of the plurality of spring attachment portions 61. For example, the attaching spring has a flat spring shape and a torsion spring shape.

When installing the lighting device 10 on the ceiling, an embedding hole is provided in the ceiling plate in advance. At this time, the diameter of the embedding hole is greater than the outer diameter of the main body portion 42m and is smaller than the diameter of the flange portion 60. The lighting device 10 inserts the second frame body 42 to the embedding hole from the interior side in a state of causing the irradiation window 12a to face the interior side, and brings an upper surface 60u of the flange portion 60 into contact with the ceiling plate. Moreover, the ceiling plate is interposed between the flange portion 60 and the attaching spring. Thereby, the lighting device 10 is attached to the ceiling plate. A lower surface side of the flange portion 60 is exposed to the ceiling. The second frame body 42 also functions as a clock decorative rim that hides the embedding hole under a cover.

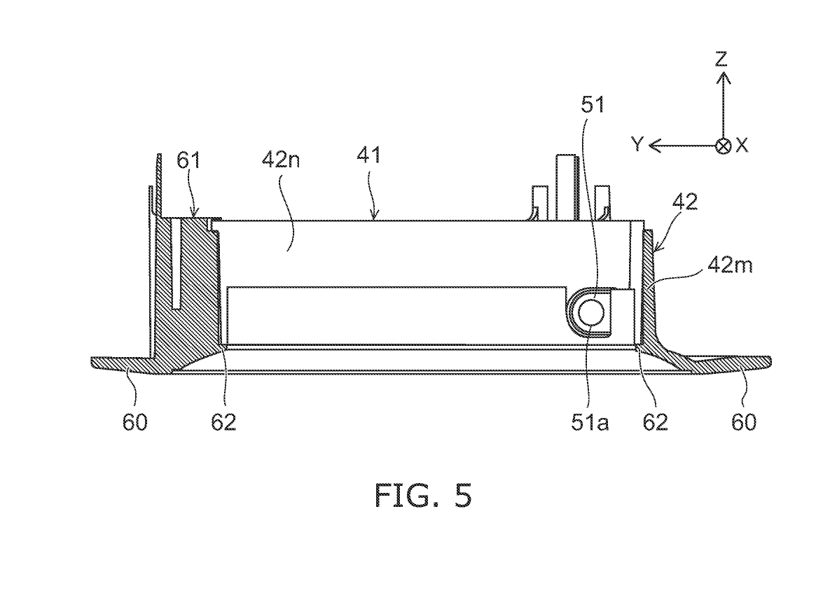

FIG. 5 is a schematic cross-sectional view that illustrates the first frame body and the second frame body related to the first embodiment.

As illustrated in FIGS. 4 and 5, the second frame body 42 is provided with a rib 62. The rib 62 is provided at the same side as the flange portion 60 of the main body portion 42m. The rib 62 is projected toward the central direction from an inner surface 42n of the second frame body 42. The inner diameter of the main body portion 42m of the portion provided with the rib 62 is smaller than the outer diameter of the first frame body 41. Thereby, the first frame body 41 inserted to the second frame body 42 comes into contact with the rib 62, and the falling-out from the second frame body 42 is suppressed. In the example, one annular rib 62 is provided. For example, a plurality of ribs 62 may be provided around the second central axis CA2 at equal intervals, without being limited thereto.

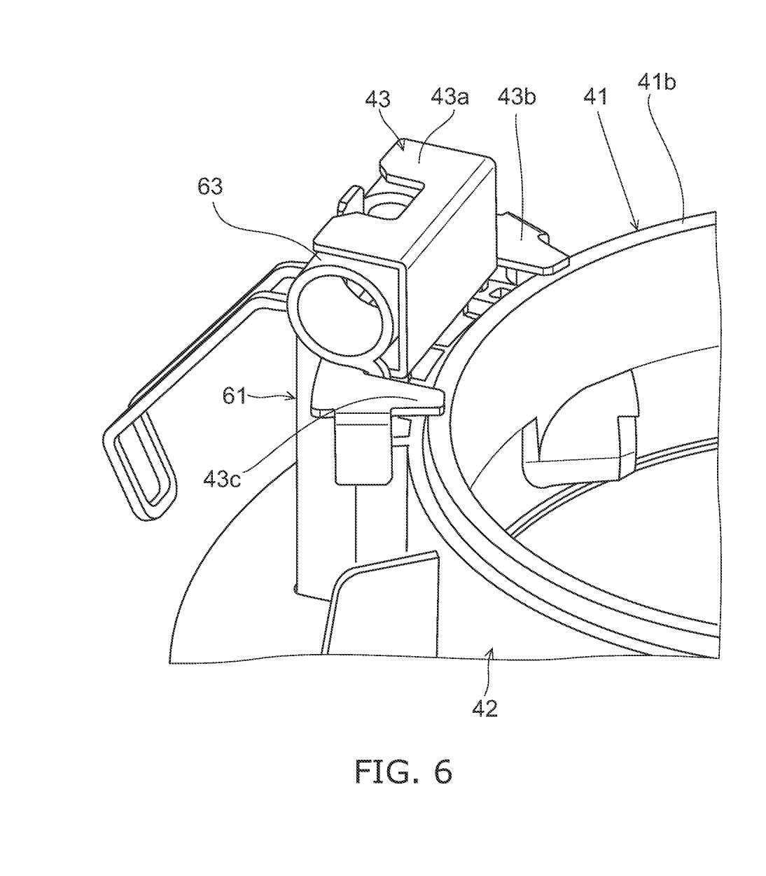

FIG. 6 is a schematic perspective view that illustrates a part of the first frame body and a part of the second frame body related to the first embodiment.

As illustrated in FIGS. 1 and 6, a stopper member 43 is attached to each spring attachment portion 61. The stopper member 43 suppresses the falling-out of the first frame body 41 from the second frame body 42. Furthermore, for example, as illustrated in FIG. 6, when the attaching spring is a torsion spring 63, the stopper member 43 suppresses the falling-out of the torsion spring 63 from the spring attachment portion 61.

For example, the stopper member 43 is attached to the spring attachment portion 61 using the screw fastening. For example, a metallic material is used in the stopper member 43. For example, the stopper member 43 is formed by bending a metallic plate.

The stopper member 43 has a spring pressing portion 43a at presses the torsion spring 63, and a pair of frame pressing portions 43b and 43c that press the first frame body 41.

The torsion spring 63 is attached to the spring attachment portion 61 by inserting the one end thereof to a groove provided in the spring attachment portion 61. The stopper member 43 brings the spring pressing portion 43a into contact with a coil portion of the torsion spring 63 attached to the spring attachment portion 61, in the state of being attached to the spring attachment portion 61. Thereby, the coil portion of the torsion spring 63 is interposed by the spring attachment portion 61 and the spring pressing portion 43a, and the torsion spring 63 is held in the spring attachment portion 61.

The frame pressing portions 43b and 43c enter the inner surface 42n of the second frame body 42 in the state of being attached to the spring attachment portion 61, and come into contact with one end 41b (the other end) of the first frame body 41 inserted to the second frame body 42. For example, the frame pressing portions 43b and 43c are elastically deformed by the contact with the one end 41b of the first frame body 41, and press the first frame body 41 against the rib 62. Thereby, the first frame body 41 is interposed by the stopper member 43 and the rib 62, and the falling-out of the first frame body 41 from the second frame body 42 is suppressed. Thereby, the first frame body 41 is supported by the second frame body 42 so as to be freely rotatable in the second rotation direction RD2.

In addition, in the example, the stopper member 43 has a function of the stopper of the torsion spring 63, and a function of the stopper of the first frame body 41. A member for the stopper of the torsion spring 63 and a member for the stopper of the first frame body 41 may be attached to the second frame body 42, without being limited thereto.

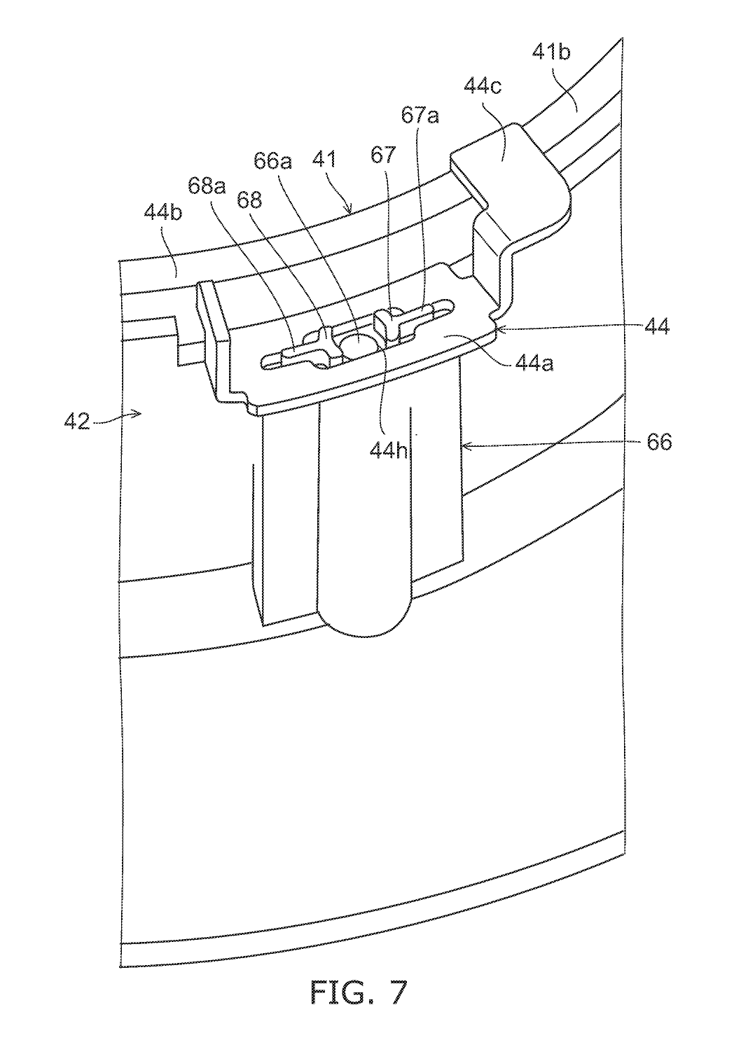

FIG. 7 is a schematic perspective view that illustrates a part of the first frame body and a part or the second frame body related to the first embodiment.

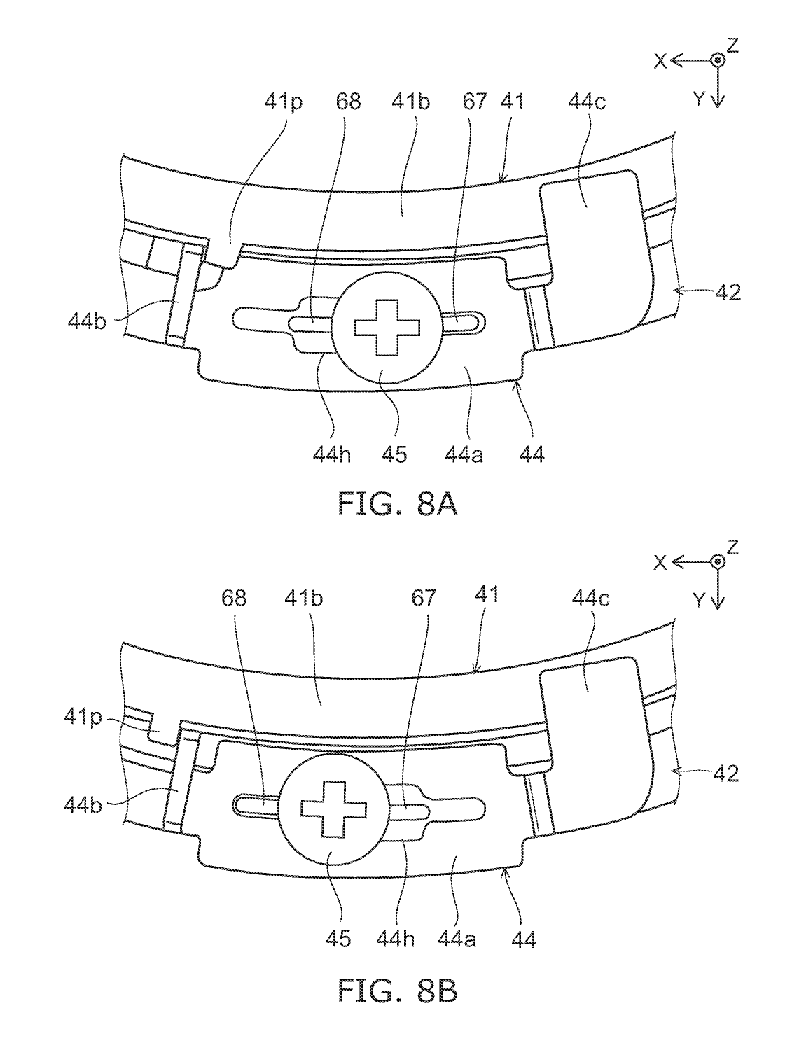

FIGS. 8A and 8B are schematic top views that illustrate a part of the first frame body and a part of the second frame body related to the first embodiment.

As illustrated in FIGS. 4, 7, 8A and 8B, the second frame body 42 is provided with a rotation stop attachment portion 66 for attaching the rotation stop member 44. The rotation stop member 44 regulates the rotation of the first frame body 41 in the second rotation direction RD2 to a predetermined quantity or less.

The rotation stop attachment portion 66 is provided with a pair of protrusions 67 and 68. The protrusion 67 has an extension portion 67a that is extended along a circumferential direction of a circle around the second central axis CA2 Similarly, the protrusion 68 also has an extension portion 68a that is extended along a circumferential direction of a circle around the second central axis CA2. The extension portion 68a of the protrusion 68 is extended in an opposite direction of the extension portion 67a of the protrusion 67. The rotation stop attachment portion 66 is provided with a screw hole 66a. The screw hole 66a is placed between the protrusions 67 and 68. The rotation stop member 44 is attached to the rotation stop attachment portion 66 using a screw 45 (a holding member) corresponding to the screw hole 66a.

The rotation stop member 44 has a main body 44a, an engagement portion 44b, and a frame pressing portion 44c. For example, as the rotation stop member 44, a metallic material is used. For example, the engagement portion 44b and the frame pressing portion 44c are formed by bending the metallic plate. The main body portion 44a is provided with a long hole 44h. The protrusions 67 and 68 can be inserted through the long hole 44h.

The thickness of the main body portion 44a is thinner than the heights of the protrusions 67 and 68. The length of the long hole 44h is longer than the length from a leading end of the extension portion 67a of the protrusion 67 to a leading end of the extension portion 68a of the protrusion 68. Furthermore, the width of long hole 44h is wider than the widths of the protrusions 67 and 68, and is narrower than the diameter of a head portion of the screw 45. The rotation stop member 44 is attached to the rotation stop attachment portion 66 in the state of causing the protrusions 67 and 68 to communicate with the long hole 44h. Moreover, the falling-out of the rotation stop member 44 from the protrusions 67 and 68 is suppressed by the screw 45. Thereby, the rotation stop member 44 is attached to the rotation stop attachment portion 66 so as to be freely movable in the circumferential direction of a circle around the second central axis CA2 in the range of the long hole 44h.

In addition, the number of the protrusions provided in the rotation stop attachment portion 66 may be one or three or more, without being limited to two. Furthermore, in the example, as the holding member configured to suppress the falling-out of the rotation stop member 44 from the protrusions 67 and 68, the screw 45 is illustrated. For example, the holding member may be an arbitrary member such as a rivet that is able to suppress the falling-out of the rotation stop member 44, without being limited to the screw 45.

The engagement portion 44b enters inside the movement path of the protrusion 41p provided on the outer surface 41g of the first frame body 41 in the state of attaching the rotation stop member 44 to the rotation stop attachment portion 66. The engagement portion 44b is engaged with the protrusion 41p and regulates the rotation of the first frame body 41 in the second rotation direction RD2 to a predetermined amount or less. Thereby, for example, it is possible to suppress the distortion of the wiring for electrically connecting a light source, an external power source or the like.

Furthermore, the rotation stop member 44 is moved in the circumferential direction along the protrusions 67 and 68 when the protrusion 41p is engaged with the engagement portion 44b. The rotation stop member 44 is moved to a first regulation position (a position illustrated in FIG. 8A) that regulates the rotation of the first frame body 41 in one direction of the second rotation direction RD2, and a second regulation position (a position illustrated in FIG. 8B) that regulates the rotation of the first frame body 41 in the other direction of the second rotation direction RD2.

Thereby, for example, the rotation quantity of the first frame body 41 in the second rotation direction RD2 can be set to 360° or more. For example, the rotation quantity of the first frame body 41 in the second rotation direction RD2 can be arbitrarily set to 365°, 370° or the like. Thereby, the lighting beam can be turned to a certain direction, while regulating the rotation to suppress the distortion of the wiring or the like. For example, there is no limit of the direction when attaching the lighting device 10 to the ceiling or the like, and thus the attaching work of the lighting device 10 can be easily performed.

For example, the frame pressing portion 44c further inwards than the inner surface 42n of the second frame body 42 in the state of being attached to the rotation stop attachment portion 66, and comes into contact with the one end 41b of the first frame body 41 inserted to the second frame body 42. For example, the frame pressing portion 44c is elastically deformed by the contact with the one end 41b of the first frame body 41, and presses the first frame body 41 against the rib 62. That is, the rotation stop member 44 also functions as a stopper of the first frame body 41. The frame pressing portion 44c may be provided as needed and can be excluded. The rotation stop member 44 may not necessarily have the function of the stopper of the first frame body 41.

In addition, the length of the frame pressing portion 44c and the lengths of the frame pressing portions 43b and 43c are longer than the protrusion quantity of the protrusion 41p from the outer surface 41g. That is, the frame pressing portion 44c and the frame pressing portions 43b and 43c retreat from the movement path of the protrusion 41p.

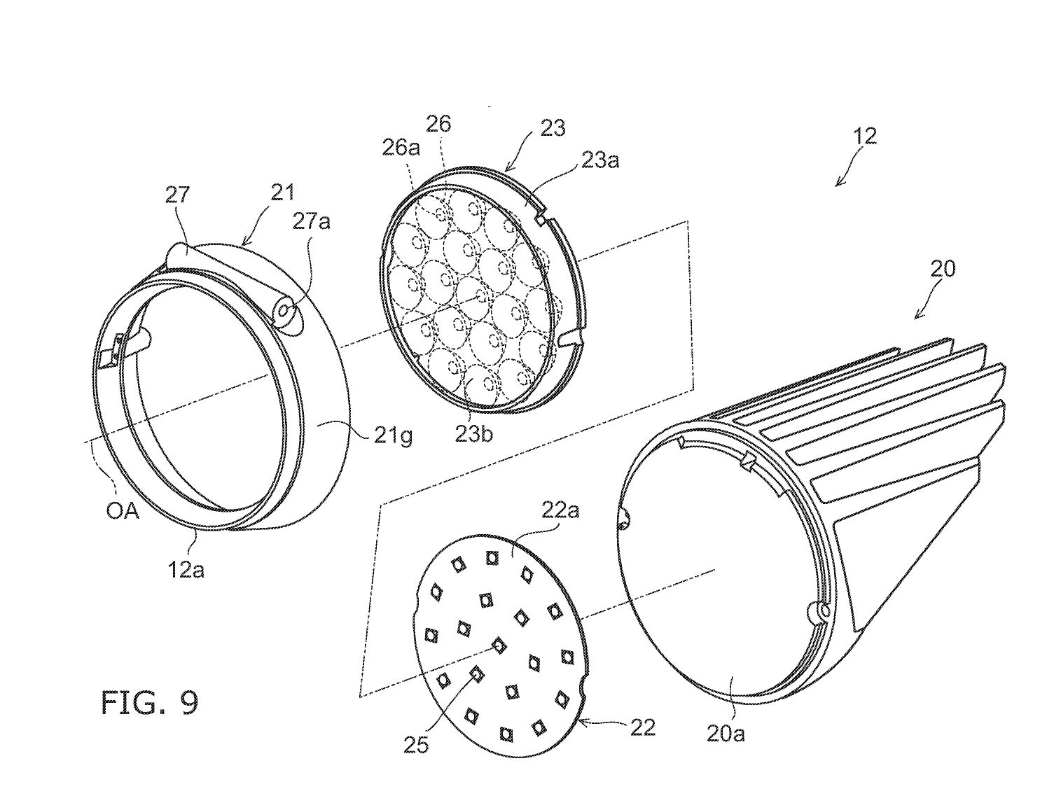

FIG. 9 is a schematic exploded perspective view that illustrates the lighting main body related to the first embodiment.

As illustrated in FIG. 9, the lighting main body 12 has the radiator 20 and the holding frame 21, and has a substrate 22 and a lens unit 23. A plurality of light sources 25 is implemented on a surface 22a of the substrate 22. For example, the plurality of light sources 25 is coaxially placed side by side. Wiring (not illustrated) is connected to the substrate 22, and electric power is supplied from the outside via the wiring. Thereby, the plurality of light sources 25 emits light depending on the electric power supply from the outside.

For example, a light emitting diode (LED) is used in the light source 25. For example, the light source 25 may be an organic light emitting diode (OLED), an inorganic electroluminescence light emitting device, an organic electroluminescence light emitting device, other electroluminescence type light emitting device or the like.

The radiator 20 is provided with an attachment surface 20a for attaching the substrate 22. The area of the attachment surface 20a is the same degree as the area of the surface 22a of the substrate 22 or is slightly greater than the area thereof. For example, the substrate 22 is stuck to the attachment 20a of the radiator 20 via a heat radiation sheet or the like. Thereby, the substrate 22 is held in the radiator 20. For example, heat generated according to the heat generation of each light source 25 is radiated by the radiator 20. For example, the influence of heat to each light source 25 can be suppressed.

In the example, although the substrate 22 has a configuration stuck to the radiator 20, for example, the substrate 22, each light source 25 or the like may be attached to the radiator 20 in a freely attachable or detachable manner. Each light source 25 may be exchangeable with respect to the lighting device 10.

For example, an optical glass, an optical plastic or the like is used in the lens unit 23. The lens unit 23 has optical transparency with respect to the light emitted from the light source 25. For example, the lens unit 23 is transparent. For example, the lens unit 23 has a cylindrical tubular portion 23a, and a lower portion 23b that blocks one end of the tubular portion 23a. The lens unit 23 is provided with a plurality of lenses 26. The plurality of lenses 26 is provided in response to the plurality of light sources 25. Each lens unit 26 is placed on an inner surface of the lower portion 23b. For example, each lens 26 has a hemispherical shape or a conical shape. In a top portion of each lens 26, a concave portion 26a configured to cover each light source 25 is provided. For example, the lens 26 condenses the light emitted from the light source 25, and improves irradiation efficiency of the light. As mentioned above, the holding frame 21 has a cylindrical shape. The lens unit 23 is fitted to the inside of the holding frame 21 and is held in the holding frame 21.

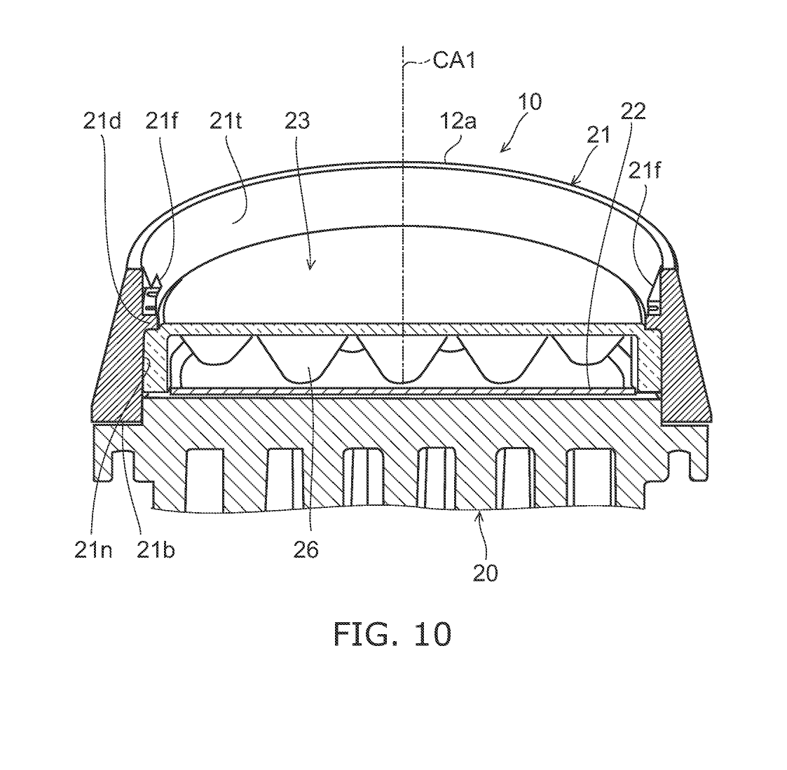

FIG. 10 is a schematic partial cross-sectional view that illustrates the lighting main body related to the first embodiment.

As illustrated in FIG. 10, on the inner surface side of the holding frame 21, a step portion 21d configured to change the inner diameter is provided. The inner diameter of a portion 21n between the step portion 21d and a rear end 21b of the inner side surface of the holding frame 21 is substantially the same as the outer diameter of the lens unit 23. The rear end 21b is an end portion of an opposite side of the end portion serving as the irradiation window 12a. Meanwhile, the inner diameter of the holing frame 21 of the portion of the step portion 21d is narrower than the outer diameter of the lens unit 23. Thereby, the lens unit 23 inserted to the holding frame 21 comes into contact with the step portion 21d, and the falling-out from the holding frame 21 is suppressed.

The radiator 20 is attached to the rear end 21b of the holding frame 21. The lens unit 23 inserted to the holding frame 21 is held in the stat of being interposed between holding frame 21 and the radiator 20. The length of the holding frame 21 along the optical axis OA and the length of the lens unit 23 along the optical axis OA are determined, for example, depending on the length of the lens 26 along the optical axis OA. The lens unit 23 is held in the holding frame 21 in the state where the positions of each light source 25 and each lens 26 are determined.

A portion 21t between the step portion 21d of the inner surface of the holding frame 21 and the irradiation window 12a is a tapered surface in which the inner diameter thereof is continuously increased from the step portion 21d toward the irradiation window 12a. The portion 21t of the inner surface of the holding frame 21 is provided with a plurality of filter attachment portions 21f for attaching the filters in a freely attachable or detachable manner. In the example, two filter attachment portions 21f are provided. The two filter attachment portions 21f are provided at the positions symmetrical to each other with the optical axis OA interposed therebetween. The number of the filter attachment portions 21f may be three or more.

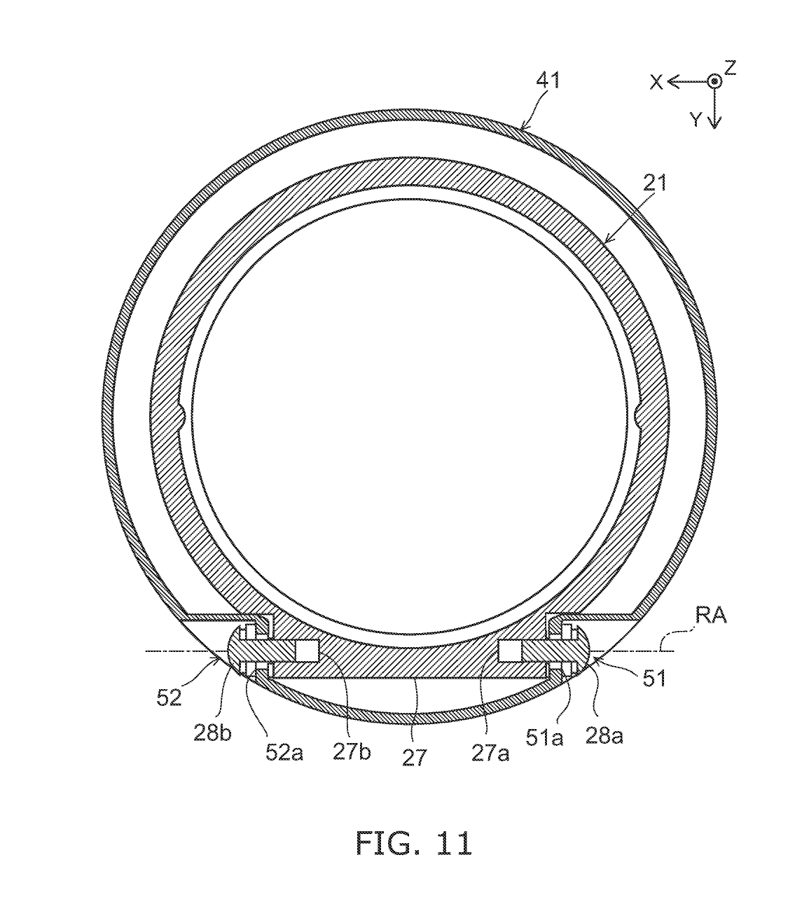

FIG. 11 is a schematic cross-sectional view that illustrates the first frame body and the holding frame related to the first embodiment.

As illustrated in FIGS. 9 and 11, on the outer surface 21g of the holding frame 21, a cylindrically elevated hinge portion 27 is provided. The hinge portion 27 is extended in a direction perpendicular to the optical axis OA. For example, the hinge portion 27 is elevated in the Y axis direction and is extended in the X axis direction. On both ends of the hinge portion 27, cylindrical attachment holes 27a and 27b extended in the extension direction of the hinge portion 27 are provided. The length of the hinge portion 27 along the X axis direction is determined depending on the distance between the pair of bearing portions 51 and 52 of the first frame body 41 along the X axis direction. The hinge portion 27 enters between the bearing portions 51 and 52, causes the attachment hole 27a to face the through hole 51a and causes the attachment hole 27b to face the through hole 52a.

A shaft 28a is inserted to the attachment hole 27a and the through hole 51a. A shaft 28b is inserted to the attachment hole 27b and the through hole 52a. Thereby, the holding frame 21 is supported by the first frame body 41 so as to be freely rotatable in the first rotation direction RD1. For example, a flat-head screw is used in the shafts 28a and 28b.

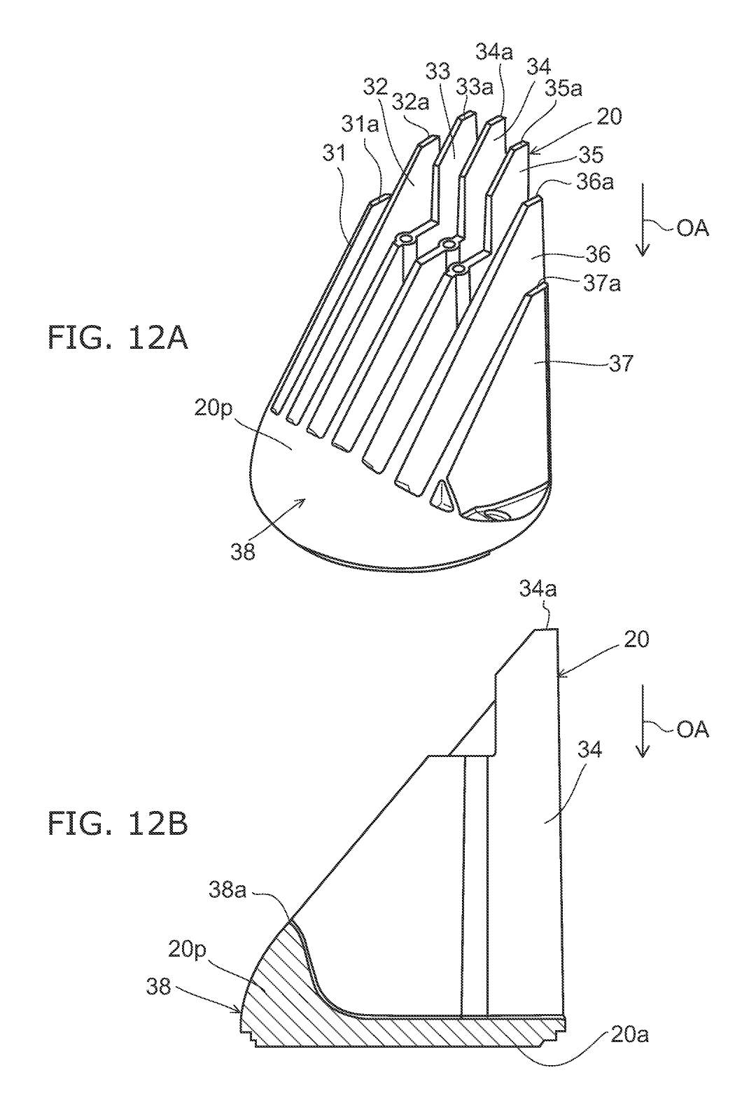

FIGS. 12A and 12B are schematic views that illustrate the radiator related to the first embodiment. FIG. 12A is a schematic perspective view and FIG. 12B is a schematic cross-sectional view.

As illustrated in FIGS. 12A and 12B, the radiator 20 is provided with a plurality of flat-plate-like radiation fins 31 to 37 and a continuous portion 38. In the example, seven radiation fins 31 to 37 are provided.

The respective radiation fins 31 to 37 are extended in a direction parallel to the optical axis OA. The respective radiation fins 31 to 37 are extended in a direction that is perpendicular to the rotation axis RA in the state where the lighting main body 12 is supported by the first frame body 41 (see FIGS. 2A and 2B). Moreover, the respective radiation fins 31 to 37 are extended in a direction that is parallel to the rotation axis RA. That is, in the example, the respective radiation fins 31 to 37 are extended in a direction parallel to the Y-Z plane and are arranged in the X axis direction. In this manner, by providing the radiator 20 with the plurality of radiation fins 31 to 37, for example, the surface area of the radiator 20 increases, and thus radiation efficiency of the radiator 20 can be increased. In addition, the number of the radiation fins 31 to 37 provided in the radiator 20 may be certain numbers of two or more, without being limited to seven.

The continuous portion 38 is a portion in each of parts of the respective radiation fins 31 to 37 is caused to continue in a part 20p exposed when the lighting main body 12 is located at the second position. For example, the continuous portion 38 is configured so that the part 20p is a curved surface. Thereby, the continuous portion 38 prevents the shapes of the respective radiation fins 31 to 37 from being exposed when locating the lighting main body 12 at the second position. In other words, the continuous portion 38 is a portion that covers the respective radiation fins 31 to 37 so that the respective radiation fins 31 to 37 are not exposed when locating the lighting main body 12 at the second position. Thereby, for example, the exterior of the lighting device 10 can be improved.

As illustrated in FIG. 12B, the continuous portion 38 causes only a part near the outer peripheries of the respective radiation fins 31 to 37 to continue. The respective radiation fins 31 to 37 are extended up to the attachment surface 20a side behind the end portion 38a of the continuous portion 38. The thickness of the continuous portion 38 in the direction perpendicular to the optical axis OA and the rotation axis RA increases toward the attachment surface 20a side (the irradiation window 12a side) from the end portion 38a. For example, the thickness of the continuous portion 38 continuously increases. Thereby, for example, moldability of the radiator 20 can be enhanced. For example, when molding the radiator 20, the radiator 20 can be easily drawn from the mold. Furthermore, for example, it is possible to suppress the stagnation of heat behind the continuous portion 38.

When the lighting main body 12 located either at the first position or at the second position, the respective end portions 31a to 37a of the respective radiation fins 31 to 37 are projected to the outside of the first frame body 41 and the second frame body 42 from the one end 41b of the first frame body 41 (see FIGS. 1, 2A and 2B). For example, when the one end 41b is an upper end, the end portions 31a to 37a are placed above the one end 41b and the one end of the second frame body 42 of the same side as the one end 41b.

Each of the lengths of the respective radiation fins 31 to 37 along the optical axis OA is reduced perpendicularly to the rotation axis RA and in the direction toward the optical axis OA from the rotation axis RA. Furthermore, each of one lengths of the respective radiation fins 31 to 37 along the optical axis OA is shortened as being separated from the center in the direction (the X axis direction) along the rotation axis RA. That is, in the example, the radiation fin 34 located in the center in the X axis direction is the longest, and the radiation fin 31 and the radiation fin 37 are the shortest.

Thereby, even when the lighting main body 12 is located at the first position or the second position, each of the respective radiation fins 31 to 37 is located inside the outer surface 42g of the main body portion 42m of the second frame body 42 in the direction perpendicular to the second central axis CA2. In other words, each of the respective radiation fins 31 to 37 is located inside the outer surface 42g when being projected to the plane (the X-Y plane) perpendicular to the second central axis CA2. In the example, each of the respective radiation fins 31 to 37 is located inside the outer surface 42g of the main body portion 42m of the second frame body 42 in the direction perpendicular to the second central axis CA2 (see FIGS. 2A and 2B).

Thereby, for example, the space required for installing the lighting device 10 can be saved. For example, the space required for an attic can be saved. Furthermore, in some cases, a plurality of lighting device 10 may be installed side by side. At this time, if the radiator 20 is projected outside the outer surface 42g, when rotating the lighting main body 12 in the second rotation direction RD2, the radiator 20 may come into contact with the radiator 20 of the next lighting device 10. On the contrary, in the lighting device 10 related to the embodiment, since the radiator 20 is located inside the outer surface 42g, even when installing the plurality of lighting devices 10 side by side, the adjustment of the direction of the second rotation direction RD2 can be smoothly performed.

Furthermore, in the lighting device 10 related to the embodiment, as mentioned above, by adjusting the length along the optical axis OA, when the lighting main body 12 is located at the second position, each of the respective radiation fins 31 to 37 does not come into contact with the first frame 41 (see FIG. 2B).

Thereby, when the lighting main body 12 is located at the second position, an interval is generated between the lighting main body 12 and the first frame 41. For example, an air passage passing from the interior side to the attic is generated, and thus it is possible to further enhance radiation efficiency when the lighting main body 12 is located at the second position.

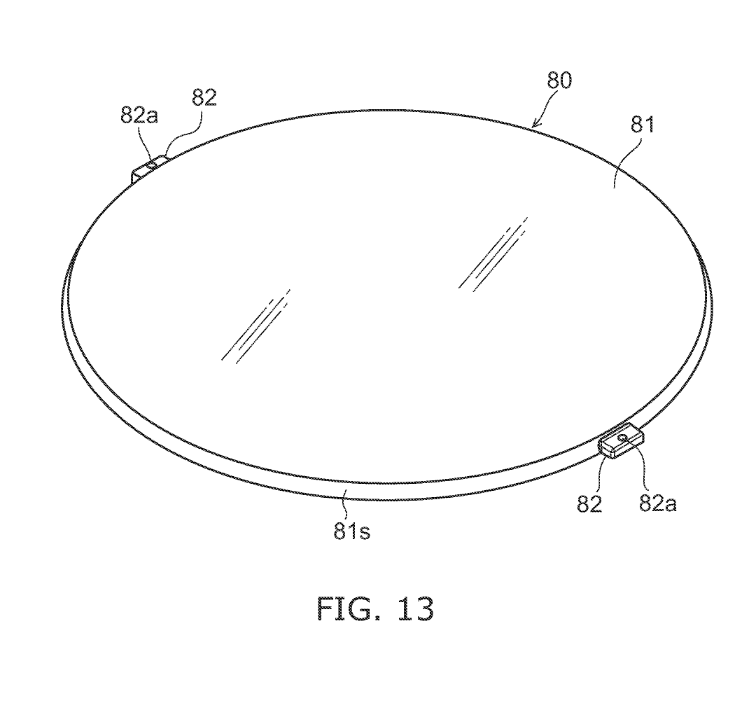

FIG. 13 is a schematic perspective view that illustrates a filter related to the first embodiment.

FIG. 13 illustrates a filter 80 that is attached to the lighting main body 12 in a freely attachable or detachable manner.

As illustrated in FIG. 13, the filter 80 has a disk-shaped filter main body 81, and a plurality of engagement claws 82. For example, the filter 80 is a color rendering property filter that cuts a predetermined wavelength to raise color rendering property. For example, the filter 80 may be other optical filters such as an ND filter and a color filter.

For example, the diameter of the filter main body 81 is substantially the same as the inner diameter of the portion in which each filter attachment portion 21f of the holding frame 21 is provided. For example, a side surface 81s of the filter main body 81 is a tapered surface. For example, the angle of the side surface 81s is substantially the same as the angle of the portion 21t of the tapered surface of the holding frame 21.

The plurality of engagement claws 82 is provided in response to the plurality of filter attachment portions 21f of the holding frame 21. Thus, in the example, two engagement claws 82 are provided. Each engagement portion 82 is provided so as to be projected in a radial direction from the side surface 81s of the filter main body 81. In the example, each engagement claw 82 has a rectangular shape. The shape of each engagement claw 82 may be an arbitrary shape that can be attached to each filter attachment portion 21f. The position of each engagement claw 82 corresponds to the position of each filter attachment portion 21f. In the example, the respective engagement claws 82 are provided at the positions symmetrical to each other with the center of the filter main body 81 interposed therebetween. Each of the engagement claws 82 is provided with a hemispherical convex portion 82a. The convex portion 82a is provided on the surface facing the optical axis direction of the engagement claw 82.

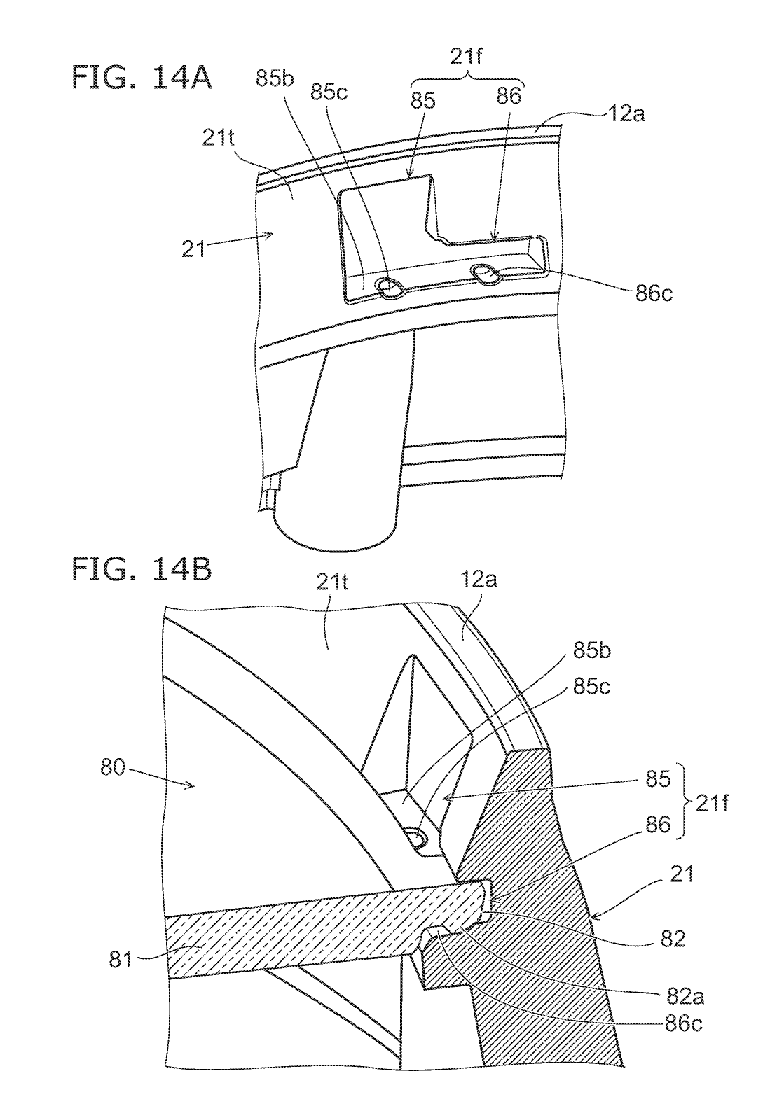

FIGS. 14A and 14B are schematic perspective views that illustrate a holding frame related to the first embodiment.

As illustrated in FIGS. 14A and 14B, the filter attachment portion 21f has an insertion-extraction portion 85 and an engagement groove 86.

The insertion-extraction portion 85 is a portion that dents a part of the portion 21t of the tapered surface of the holding frame 21 and is substantially parallel to the optical axis OA. The depth (a dent quantity from the inner surface of the holding frame 21) of the insertion-extraction portion 85 corresponds to the length (a projection quantity from the side surface 81s) of the engagement claw 82 of the filter 80. Thereby, in the insertion-extraction portion 85, the engagement claw 82 can be inserted to and extracted from the irradiation window 12a side in the optical axial direction. A lower portion 85b of the insertion-extraction portion 85 is provided with a concave portion 85c engaged with the convex portion 82a of the engagement claw 82.

The engagement groove 86 is circumferentially extended from the lower portion 85b of the insertion-extraction portion 85. The height of the engagement groove 86 is slightly higher than the thickness of the engagement claw 82. The engagement groove 36 is provided a concave portion 86c engaged with the convex portion 82a of engagement claw 82.

When attaching the filter 80, each engagement claw 82 is caused to enter the insertion-extraction portion 85 of each filter attachment portion 21f, and the filter 30 is inserted to the holding frame 21. Each engagement claw 82 is pressed against the lower portion 85b of each insertion-extraction portion 85, and the filter 80 is rotated around the optical axis. Each engagement claw 82 is caused to enter each engagement groove 86, thereby to engage each convex portion 82a and each concave portion 86c with each other. Thereby, as illustrated in FIG. 14B, the falling-out of the filter 80 in the optical axial direction is regulated by the engagement between each engagement claw 82 and each engagement groove 86, the rotation of the filter 80 around the optical axis is regulated by the engagement between each convex portion 82a and each concave portion 86c, and thus the filter 80 is held by each filter attachment portion 21f.

When detaching the filter 80, the filter 80 is rotated in an opposite direction of the direction at the time of the attachment, each engagement claw 82 is drawn from each engagement groove 86, and each engagement claw 82 is drawn to the irradiation window 12a side from each insertion-extraction portion 85.

In this manner, in the lighting device 10, the filter 80 can be easily attached to or (detached from the holding frame 21 by the simple operation of merely rotating the filter 80 around the optical axis. Furthermore, the filter 80 can be suitably held in each filter attachment portion 21f, by the engagement between each engagement claw 82 and each engagement groove 86 and the engagement between each convex portion 82a and each concave portion 86c. In addition, on the contrary, the concave portion may be provided in the engagement claw 82, and the concave portion may be provided in the insertion-extraction portion 85 and the engagement groove 86. Furthermore, the shape of the concave portion may be an arbitrary shape capable of being engaged, without being limited to a hemispherical shape.

In the lighting device 10 related to the embodiment, the rotation stop member 44 is moved to the first regulation position and the second regulation position by the engagement with the protrusion 41p provided in the first frame body 41. Thereby, the degree of freedom for changing degree of the second rotation direction RD2 can be further enhanced in the lighting device 10. For example, in a configuration in which the rotation stop member 44 is fixed to the second frame body 42 and is not circumferentially moved, the rotation quantity of the first frame body 41 in the second rotation direction RD2 is about 350° to 355°. On the contrary, in the lighting device 10 related to the embodiment, the rotation quantity of the first frame body 41 in the second rotation direction RD2 can be set to 360° or more.

Furthermore, in the lighting device 10, the first frame body 41 has a longitudinal tubular shape. Thereby, for example, the deformation of the first frame body 41 can be suppressed when adjusting the direction of the illumination beam by rotating the lighting main body 12 in the second rotation direction RD2, and thus the adjustment of the direction of the second rotation direction RD2 can be smoothly performed.

### Second Embodiment

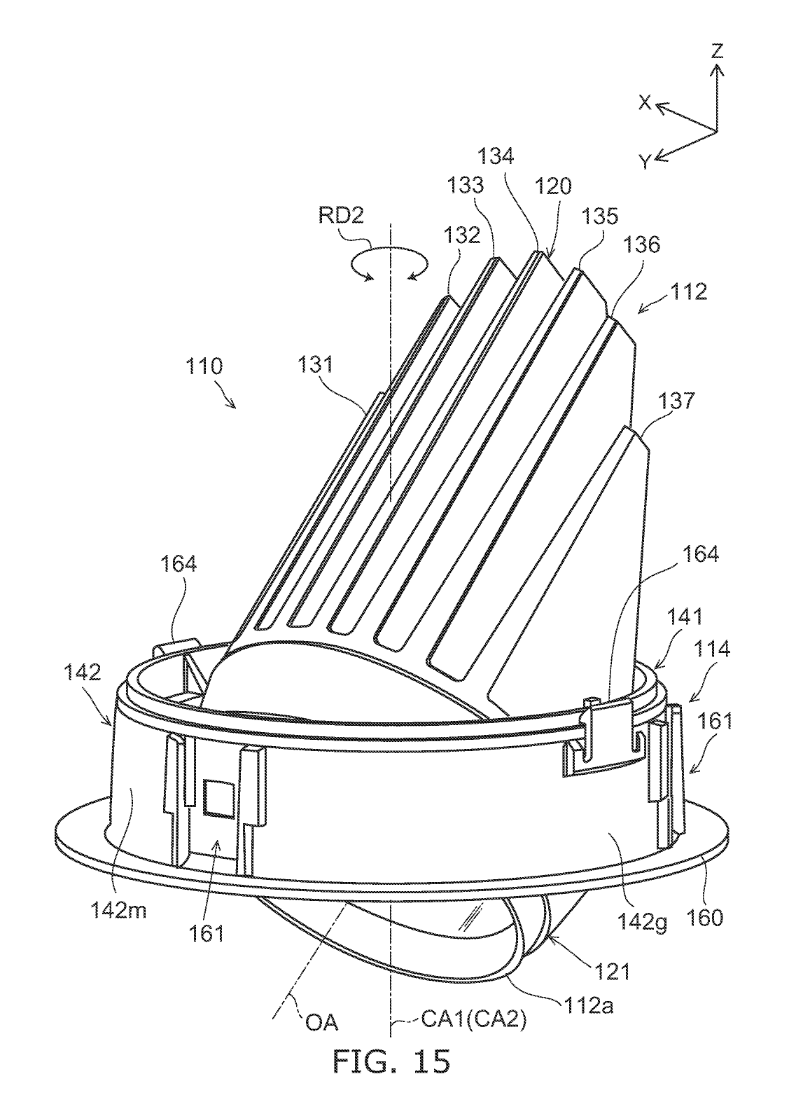

FIG. 15 is a schematic perspective view that illustrates a lighting device related to a second embodiment.

As illustrated in FIG. 15, as in the lighting device 10 of the above-mentioned first embodiment, a lighting device 110 related to the embodiment includes a lighting main body 112 that irradiates light toward an object, and a support portion 114 that supports the lighting main body 112. In the lighting device 110, the detailed descriptions of the same functions and configurations as the first embodiment will be omitted.

The lighting main body 112 has a radiator 120 and a holding frame 121. In the radiator 120, a plurality of radiation fins 131 to 137 is arranged side by side. The holding frame 121 is provided with an irradiation window 112a for emitting the illumination beam. As mentioned in the first embodiment, the lighting main body 112 is further provided with the substrate 22, the lens unit 23 or the like. The lighting main body 112 emits the light emitting light of the light source 25 as the illumination beam from the irradiation window 112a.

The support portion 114 has a first frame body 141 and a second frame body 142. For example, the first frame body 141 and the second frame body 142 have a tubular shape. In the example, the lighting main body 112 is also supported by the support portion 114 so as to be freely rotatable in the first rotation direction RD1 and the second rotation direction RD2, using the first frame body 141 and the second frame body 142.

The second frame body 142 has a tubular-shape main body portion 142m capable of inserting the first frame body 141 therethrough, and a flange portion 160 projected outward from an outer surface 142g of one end of the main body portion 142m. The main body portion 142m is provided with a plurality of spring attachment portions 161 for attaching the attaching spring. For example, the three spring attachment portions 161 are placed around the second central axis CA2 at equal intervals. In the example, for example, by interposing the ceiling plate between the flange portion 160 and the attaching spring, the lighting device 110 is attached to the ceiling.

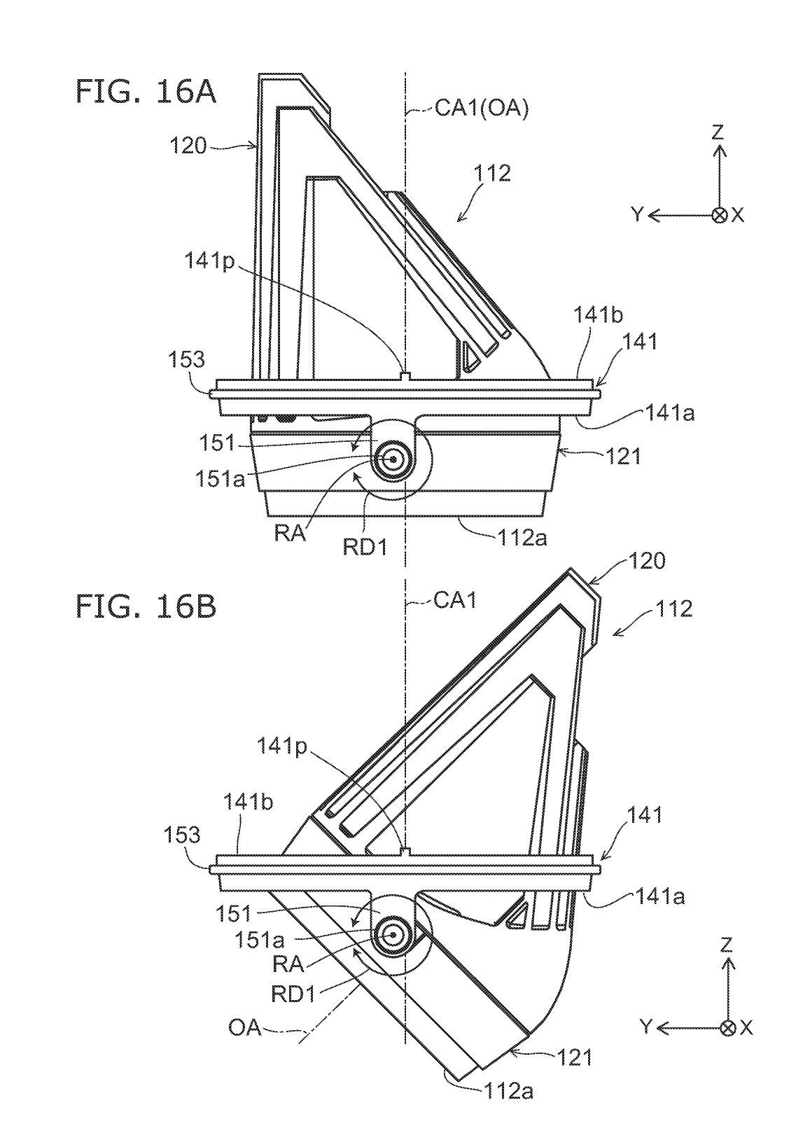

FIGS. 16A and 16B are schematic side views that illustrate the lighting main body and the first frame body related to the second embodiment.

As illustrated in FIGS. 16A and 16B, the first frame body 141 is provided with a pair of bearing portions 151. Each bearing portion 151 is extended from one end 141a of the first frame body 141 along a direction along the first central axis CA1. The respective bearing portions 151 are provided, for example, at the positions facing each other with the first central axis CA1 interposed therebetween. The respective bearing portions 151 are provided with a through hole 151a for inserting the shaft therethrough.

For example, in the holding frame 121, at a position facing each of the through holes 151a of each bearing portion 151 in the state of being inserted to the first frame body 141, a cylindrical attachment hole for inserting the shaft therethrough is provided. Thereby, by inserting the shaft to each of the respective through holes 151a and the respective attachment holes, the lighting main body 112 is supported by the first frame body 141 so as to be freely rotatable around the rotation axis RA. Thereby, in the example, the lighting main body 112 is also rotated in the first rotation direction RD1, and is moved to the first position illustrated in FIG. 16A or the second position illustrated in FIG. 16B. At the first position, the optical axis OA of the illumination beam is parallel to the first central axis CA1. At the second position, the optical axis OA of the illumination beam is inclined with respect to the first central axis CA1.

In the example, each of the respective radiation fins 131 to 137 is located further inside the outer surface 142g of the main body portion 142m of the second frame body 142 in a direction perpendicular to the second central axis CA2, even when the lighting main body 112 is located either at the first position or at the second position. Furthermore, each of the respective radiation fins 131 to 137 does not come into contact with the first frame body 141 when the lighting main body 112 is located at the second position.

In the first frame body 141, the distance between the rotation axis RA and the first central axis CA1 along the Y axis direction is shorter than the distance between the rotation axis RA of the first frame body of the above-mentioned first embodiment and the first central axis CA1 along the Y axis direction. The position of the rotation axis RA in the Y axis direction may be substantially the same as the position of the first central axis CA1 in the Y axis direction. That is, the rotation axis RA may intersect with the first central axis CA1.

The height (the length along the first central axis CA1) of the first frame body 141 is lower than the height of the first frame body 41 of the above-mentioned first embodiment. For example, the first frame body 141 can also have an annular shape. In the specification, a shape similar to the annular shape having the relatively low height is also included in a tubular shape.

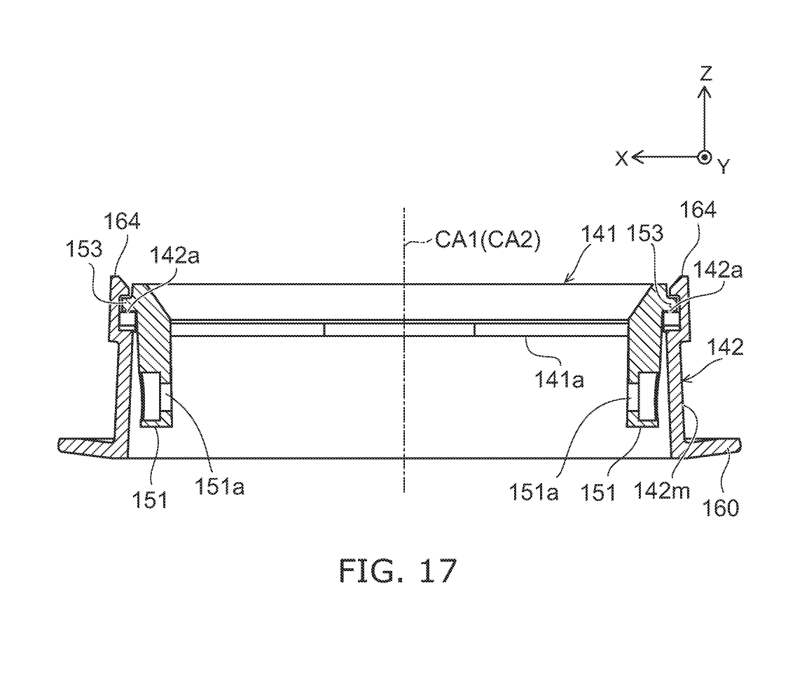

FIG. 17 is a schematic cross-sectional view that illustrates the first frame body and the second frame body related to the second embodiment.

As illustrated in FIGS. 16A, 16B and 17, on the outer surface of the first frame body 141, a rib 153 projected outward is provided. The outer diameter of the first frame body 141 of a portion between the rib 153 and the one end 141a is smaller than the inner diameter of the second frame body 142. Meanwhile, the outer diameter of the first frame body 141 of the rib portion 153 is greater than the inner diameter of the second frame body 142. The first frame body 141 brings the rib 153 into contact with the one end 142a of the second frame body 142 when being inserted to the second frame body 142. Thereby, the falling-out in one direction from the second frame body 142 is regulated.

As illustrated in FIGS. 15 and 17, the second frame body 142 is provided with a pair of engagement claws 164. For example, the respective engagement claws 164 are placed at the positions symmetrical to each other with the second central axis CA2 interposed therebetween. The respective engagement claws 164 are elastically deformed to allow the insertion of the rib 153, and then are engaged with the rib 153 to regulate the falling-out of the first frame body 141 in the other direction from the second frame body 142. Thereby, the falling-out of the first frame body 141 is regulated, and the first frame body 141 is supported by the second frame body 142 so as to be freely rotatable in the second rotation direction RD2. In addition, the number of the engagement claw 164 may be three or more, without being limited to two.

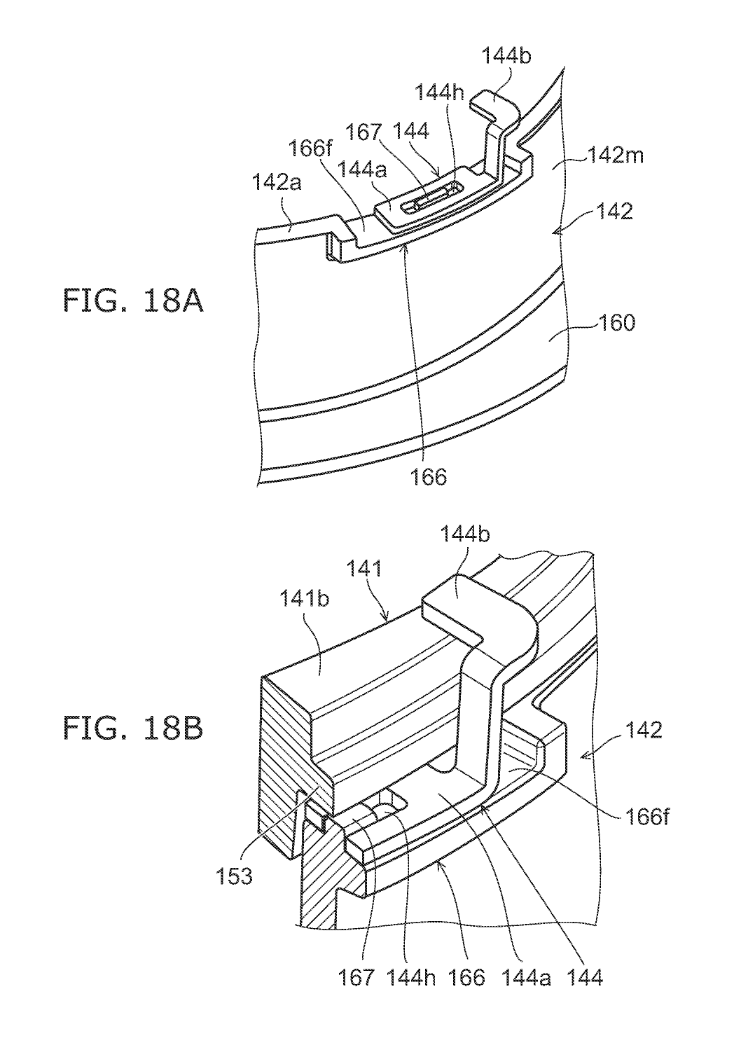

FIGS. 18A and 18B are schematic views that illustrate the second frame body related to the second embodiment.

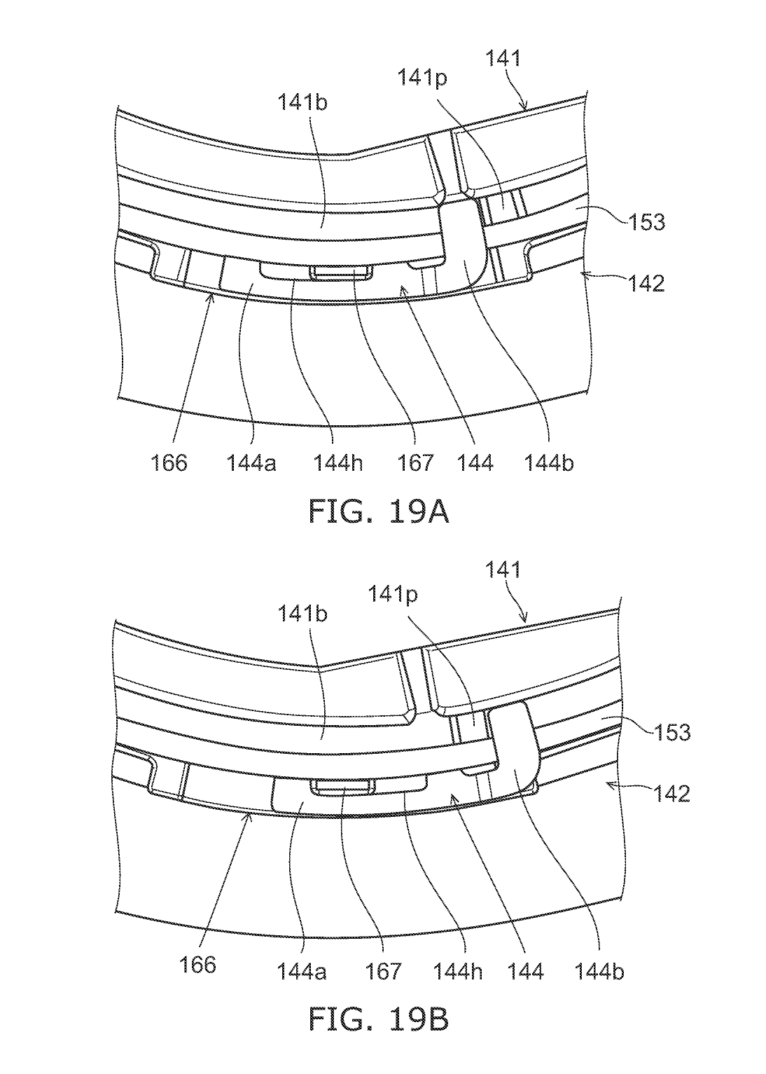

FIGS. 19A and 19B are schematic top views that illustrate a part of the first frame body and a part of the second frame body related to the second embodiment.

As illustrated in FIG. 18A, the second frame body 142 is provided with a rotation stop attachment portion 166 for attaching a rotation stop member 144. The rotation stop attachment portion 166 has a support surface 166f dented from the one end 142a of the second frame body 142. The support surface 166f is provided with a protrusion 167. The protrusion 167 is extended along a circumferential direction of a circle around the second central axis CA2. The projection quantity of the protrusion 167 from the support surface 166f is smaller than the dent quantity of the support surface 166f from the one end 142a. That is the protrusion 167 is not projected from the one end 142a in the direction along the second central axis CA2.

The rotation stop member 144 has a main body portion 144a and an engagement portion 144b. The main body portion 144a is provided with a long hole 144h through which the protrusion 167 can be inserted. The thickness of the main body portion 144a is thinner than the height of the protrusion 167. The length of the long hole 144h is longer than the length of the protrusion 167 in the circumferential direction. Furthermore, the width of the long hole 44h is wider than the width of the protrusion 167. Thereby, the rotation stop member 144 is attached to the rotation stop attachment portion 166 so as to be freely movable in the circumferential direction of the circle around the second central axis CA2 in the range of the long hole 144h.

As illustrated in FIG. 18B, the rotation stop member 144 is interposed between the first frame body 141 and the rotation stop attachment portion 166. More specifically, the rotation stop member 144 is interposed between the rib 153 and the support surface 166f. Thereby, the falling-out of the rotation stop member 144 from the protrusion 167 is suppressed.

The engagement portion 144b enters the movement path of a protrusion 141p provided in the first frame body 141 in the state of attaching the rotation stop member 144 to the rotation stop attachment portion 166. In the example, the protrusion 141p is projected from the one end 141b of the first frame body 141 in the direction along the first central axis CA1 (see FIGS. 16A and 16B). The engagement portion 144b inwards the outer surface of the first frame body 141 in the state of attaching the rotation stop member 144 to the rotation stop attachment portion 166. For example, the engagement portion 144b comes into contact with the one end 141b of the first frame body 141. Thereby, the engagement portion 144b is engaged with the protrusion 141p, and regulates the rotation of the first frame body 141 in the second rotation direction RD2 to a predetermined quantity or less.

When the protrusion 141p is engaged with the engagement portion 144b, the rotation stop member 144 is circumferentially moved along the protrusion 167. The rotation stop member 144 is moved to a first regulation position (a position illustrated in FIG. 19A) that regulates the rotation of the first frame body 141 in one direction of the second rotation direction RD2, and a second regulation position (a position illustrated in FIG. 19B) that regulates the rotation of the first frame body 141 in the other direction of the second rotation direction RD2.

Thereby, in the lighting device 110 related to the embodiment, for example, the rotation quantity of the first frame body 141 in the second rotation direction RD2 can also be set to 360° or more. The degree of freedom of the change of the degree of the rotation of the second rotation direction RD2 can be further enhanced. The lighting beam can be turned to an arbitrary direction, while regulating the rotation to suppress the distortion of the wiring or the like. The attaching work of the lighting device 110 can be easily performed.

In the support portions 14 and 114 related to the above-mentioned each embodiment, the lighting main body 12 is supported so as to be freely rotatable in the first rotation direction RD1 and the second rotation direction RD2. The support portion may support the lighting main body so as to be freely rotatable only in the second rotation direction RD2. In the case, for example, the first frame body may support the lighting main body in the state of inclining the optical axis OA of the illumination beam with respect to the first central axis CA1 (the second position state)

Although some embodiments have been described, such embodiments are presented as an example but are not intended to limit the scope of the embodiments. The new embodiments can be performed by various other embodiments, and various omissions, substitutions and chances can be made within the scope that does not apart from the gist thereof. The embodiments and the modifications thereof are included in the scope and the gist of the embodiment, and are included in the claims and the equivalents thereof.

What is claimed is:

1. A lighting device comprising:
a lighting main body having an irradiation window that emits light; and
a support portion that has a first tubular frame body through which the lighting main body can be inserted, and a second tubular frame body through which the first frame body can be inserted, the support portion supporting the lighting main body inserted through the first frame body in a state of inclining an optical axis of the light with respect to a central axis of the first frame body, and the support portion supporting the first frame body inserted through the second frame body so as to be a freely rotatable around a central axis of the second frame body,
wherein the support portion has a rotation stop member that is engaged with a protrusion provided in the first frame body to regulate the rotation of the first frame body, and
the rotation stop member is attached to the second frame body so as to be freely movable in a circumferential direction of a circle around the central axis of the second frame body, and is moved to a first regulation position that regulates the rotation of the first frame body in one direction around the central axis of the second frame body, and a second regulation position that regulates the rotation thereof in the other direction.

2. The device according to claim 1,
wherein the second frame body has a rotation stop attachment portion for attaching the rotation stop member,
the rotation stop attachment portion has a protrusion that extends along a circumferential direction or a circle around the central axis of the second frame body, and
the rotation stop member has a long hole through which the protrusion can be inserted, and is moved to the first regulation position and the second regulation position in the range of the long hole.

3. The device according to claim 2,
wherein a holding member adapted to suppress falling-out of the rotation stop member from the protrusion is attached to the rotation stop attachment portion.

4. The device according to claim 2,
wherein the rotation stop member is interposed between the first frame body and the rotation stop attachment portion, and the falling-out from the protrusion is suppressed.

5. The device according to claim 1,
wherein a rotation quantity of the rotation of the first frame body around the central axis of the second frame body is 360° or more.

6. The device according to claim 1,
wherein the second frame body coaxially supports the first frame body.

7. The device according to claim 1,
wherein the first frame body supports the lighting main body so as to be freely rotatable around a rotation axis extending in a first direction perpendicular to the central axis of the first frame body, and is able to move the lighting main body to a first position in which an optical axis of the light is parallel to the central axis, and a second position in which the optical axis is inclined with respect to the central axis of the first frame body.

8. The device according to claim 7,
wherein the rotation axis is separated from the central axis in the second direction that is perpendicular to the central axis of the first frame body and the first direction, respectively, and
the first frame body projects the irradiation window from one end of the first frame body to the outside of the first frame body at the second position.

9. The device according to claim 8,
wherein the lighting main body has a radiator provided on an opposite side of the irradiation window, and
the first frame body projects a part of the radiator from the one end of the first frame body to the outside of the first frame body at the second position.

10. The device according to claim 9,
wherein the radiator has a plurality of radiation fins that extends in a direction parallel to the optical axis, extends in a direction perpendicular to the rotation axis, and is arranged in a direction parallel to the rotation axis.

11. The device according to claim 10,
wherein the radiator has a continuous portion by which a part of each of the plurality of radiation fins continues in the part of the radiator.

12. The device according to claim 10,
wherein an end portion of each of the plurality of radiation fins is projected from the other end of the first frame body to the outside of the first frame body and the second frame body,
a length of each of the plurality of radiation fins along the optical axis is reduced in a direction perpendicular to the rotation axis and toward the optical axis from the rotation axis, and
each of the plurality of radiation fins is located inside an outer surface of the second frame body in a direction perpendicular to the central axis of the second frame body when the lighting main body is located either at the first position or at the second position.

13. The device according to claim 12,
wherein each of the plurality of radiation fins does not come into contact with the first frame body when the lighting main body is located at the second position.

14. The device according to claim 7
wherein the rotation axis intersects with the central axis of the first frame body.

15. The device according to claim 9,
wherein the radiator has an attachment surface for attaching a substrate, and
the substrate has a surface and includes a plurality of light sources provided on the surface.

16. The device according to claim 15,
wherein the light source is a light emitting diode.

17. The device according to claim 15,
wherein the lighting main body has a lens unit that is provided with a plurality of lenses each corresponding to each of the plurality or light sources.

18. The device according to claim 1,
wherein the lighting main body has a plurality of filter attachment portions for attaching the filter in a freely attachable or detachable manner.

19. The device according to claim 18,
wherein the filter has a plurality of engagement claws each corresponding to each of the plurality of filter attachment portions, and
the plurality of filter attachment portions has an insertion-extraction portion that inserts to or extracts the engagement claws in an optical axial direction from the irradiation window side, and an engagement groove that circumferentially extends from a lower portion of the insertion-extraction portion and is engaged with the engagement claws.

20. The device according to claim 1,
wherein the second frame body has a tubular main body portion, a flange portion projecting outward from an outer surface of the main body portion, and a plurality of spring attachment portions for attaching an attaching spring.
